(19) United States
(12) Patent Application Publication
(10) Pub. No.: US 2006/0044793 A1
(43) Pub. Date: Mar. 2, 2006

(54) Backlight assembly and liquid crystal display apparatus having the same

(76) Inventor: Kyung-Rok Ko, (US)

Correspondence Address: CANTOR COLBURN, LLP, 55 GRIFFIN ROAD SOUTH, BLOOMFIELD, CT, 06002, US

(21) Appl. No.: 11/176,090

(22) Filed: Jul. 7, 2005

(30) Foreign Application Priority Data
Aug. 28, 2004 (KR) 2004-68225

(51) Int. Cl. F21L 4/00

(52) U.S. Cl. 362/190

(57) ABSTRACT

A backlight assembly includes a receiving container, a first mold, a voltage applying part and lamps. The receiving container includes a bottom portion and a side portion to provide a receiving space. The first mold is disposed at an end portion of the receiving container. The voltage applying part slides into the first mold to become fixably attached to the first mold. The voltage applying part includes conductive material. The lamps are combined with the voltage applying part parallel to each other. The lamps generate light when a driving voltage is applied to the lamps through the voltage applying part. A liquid crystal display apparatus includes the backlight assembly, a liquid crystal display panel displaying images using light generated from the backlight assembly, and a top chassis fixing the liquid crystal display panel to the backlight assembly.

### CROSS-REFERENCE TO RELATED APPLICATIONS

This application claims priority to Korean Patent Application No. 2004-68225 filed on Aug. 28, 2004 and all the benefits accruing therefrom under 35 U.S.C. §119, and the contents of which are herein incorporated by reference in its entirety.

### BACKGROUND OF THE INVENTION

1. Field of the Invention

The present invention relates to a backlight assembly and a liquid crystal display apparatus having the backlight assembly. More particularly, the present invention relates to a backlight assembly that provides a liquid crystal display panel with light and a liquid crystal display apparatus having the backlight assembly.

2. Description of the Related Art

Generally, a liquid crystal display (LCD) apparatus is one of flat type display apparatus. The LCD apparatus has many merits such as thin thickness, low weight, low driving voltage and low power consumption, making it well suited for a variety of applications.

An LCD apparatus does not by itself emit light, but rather requires a backlight assembly in order to display an image.

Recently, LCD apparatuses have become larger, thereby requiring larger backlight assemblies.

The backlight assembly is classified either as an edge illumination type or a direct illumination type in accordance with a position of a light source. The direct illumination type backlight assembly is appropriate for larger LCD apparatuses and comprises a plurality of lamps disposed under a LCD panel that are arranged in parallel with each other.

Recently, a method of driving all of the lamps by one inverter has been developed in order to reduce manufacturing cost and enhance stability. According to the method, each of a plurality of lamps having external electrodes formed on outer surfaces of the lamp body is arranged in parallel with each other, and a voltage applying part that applies voltage to the lamps is required.

According to a conventional voltage applying part, the conventional voltage applying part is fixed to a mold by a screw or by soldering. Therefore, the conventional voltage applying part is unstably fixed to the mold, which may cause the conventional voltage applying part to separate from the mold. Furthermore, in order to fix the conventional voltage applying part to the mold, a screwing process or soldering process is required, which is time consuming, thereby lowering productivity.

### SUMMARY OF THE INVENTION

The present invention provides a backlight assembly capable of enhancing the facility of assembling the backlight assembly and reducing manufacturing cost.

The present invention also provides a liquid crystal display apparatus having the above backlight assembly.

In an exemplary backlight assembly according to the present invention, the backlight assembly includes a receiving container, a first mold, a voltage applying part and a plurality of lamps. The receiving container includes a bottom portion and a side portion to provide a receiving space. The first mold is disposed at an end portion of the receiving container. The voltage applying part slides on the first mold to become fixably to the first mold. The voltage applying part includes a conductive material. The lamps are combined with the voltage applying part and disposed substantially parallel to each other. The lamps generate light when a driving voltage is applied to the lamps through the voltage applying part.

In an exemplary liquid crystal display (LCD) apparatus according to the present invention, the LCD apparatus includes a backlight assembly, a liquid crystal display panel and a top chassis. The backlight assembly includes a receiving container, a first mold disposed at an end portion of the receiving container, a voltage applying part that slides on the first mold to become fixably attached to the first mold, and a plurality of lamps. Each of the lamps has an external electrode formed on an outer surface of an end portion of the respective lamps and is combined with the voltage applying part. The liquid crystal display panel displays images using light generated from the backlight assembly. The top chassis fixes the liquid crystal display panel to the backlight assembly.

According to the present invention, the voltage applying part is combined with the first mold through a sliding action. Therefore, no additional process for combining the voltage applying part with the first mold, for example, screwing, soldering, etc. is required, thereby lowering costs of manufacture and enhancing productivity.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating a backlight assembly according to an exemplary embodiment of the present invention;

FIG. 2 is a perspective view illustrating a voltage applying part that is shown in FIG. 1;

FIG. 3 is a perspective view illustrating a first mold that is shown in FIG. 1;

FIG. 4 is a perspective view illustrating the voltage applying part of FIGS. 1 and 2 and the first mold of FIGS. 1 and 3 combined with each other;

FIG. 5 is a backside view of the combined voltage applying part and first mold of FIG. 4;

FIG. 6 is a cross-sectional view of the combined voltage applying part and first mold taken along line I-I′ in FIG. 4;

FIG. 7 is an exploded perspective view illustrating a backlight assembly according to another exemplary embodiment of the present invention;

FIG. 8 is a perspective view illustrating a second mold that is shown in FIG. 7;

FIG. 9 is a cross-sectional view illustrating the backlight assembly of FIG. 7;

FIG. 10 is an exploded perspective view illustrating a second mold, a diffusion plate and an optical sheet according to still another exemplary embodiment;

FIG. 11 is a perspective view illustrating the second mold of FIG. 10; and

FIG. 12 is an exploded perspective view illustrating a liquid crystal display apparatus according to an exemplary embodiment of the present invention.

### DETAILED DESCRIPTION OF THE INVENTION

Hereinafter, the embodiments of the present invention will be described in detail with reference to the accompanied drawings.

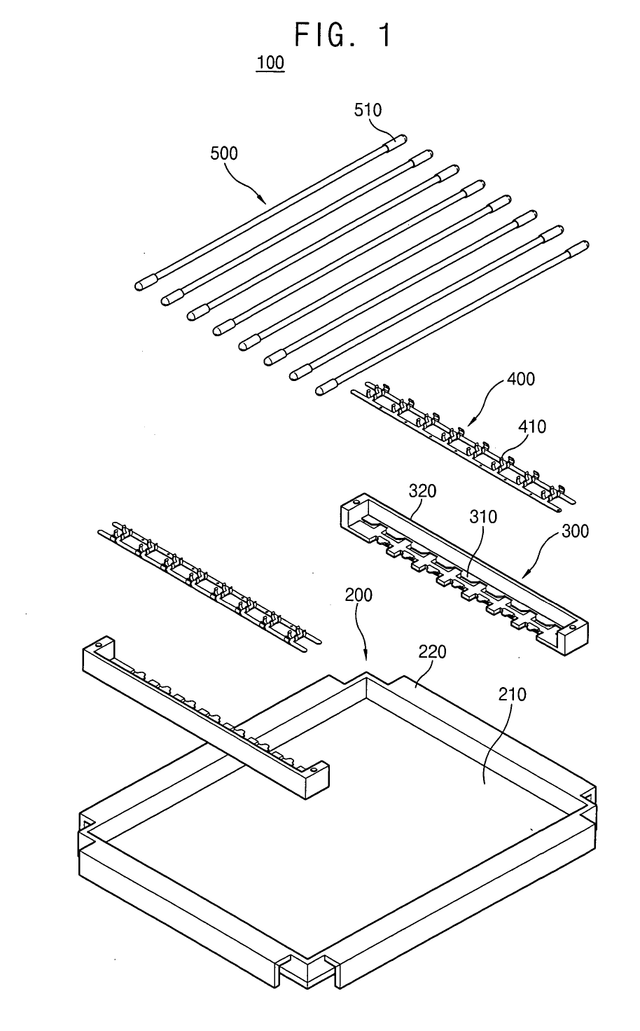

FIG. 1 is an exploded perspective view illustrating a backlight assembly according to an exemplary embodiment of the present invention.

Referring to FIG. 1, a backlight assembly 100 includes a receiving container 200, a first mold 300, a voltage applying part 400 and a lamp 500.

The receiving container 200 includes a bottom portion 210 and a side portion 220 extended from edge portions of the bottom portion 210, so that a receiving space is defined by the bottom portion 210 and the side portion 220. The side portion 220 has a n-shaped cross-section in order to define a combination space and enhance facility of combination. The receiving container 200 may include, for example, metal.

The first mold 300 is disposed at side portion 220 of the receiving container 200. The first mold 300 includes a combination portion 310 for combining with the voltage applying part 400, and a sidewall 320 extended upwardly from the combination portion 310. When being assembled, the voltage applying part 400 is disposed on the combination portion 310. When the first mold 300 is assembled with the receiving container, the combination portion 310 is disposed on the bottom portion 210 of the receiving container 200, and the sidewall 320 is disposed on the side portion 220 of the receiving container 200. The first mold 300 includes dielectric material for providing electrical insulation between the receiving container 200 including metal and the voltage applying part 400 including metal.

The voltage applying part 400 is fixed at the first mold 300 disposed at a side portion of the receiving container 200. The voltage applying part 400 slides along a longitudinal direction of the lamp 500 to be fixed to the combination portion 310 of the first mold 300. The voltage applying part 400 includes a clip portion 410 for fixing the lamp 500. The voltage applying part 400 includes metal, and applies driving voltage provided from an inverter (not shown) to the lamp 500.

In this embodiment, the voltage applying part 400 includes multiple clip portions 410, and each of the lamps 500 is fixed to corresponding one of the clip portions 410 of the voltage applying part 400 such that the lamps 500 are substantially parallel with each other. Each of the lamps 500 has an external electrode 510 formed on an outer surface of both end portions of each of the lamps 500. The driving voltage is applied to the external electrodes 510 through the voltage applying part 400 so that the lamps 500 generate light.

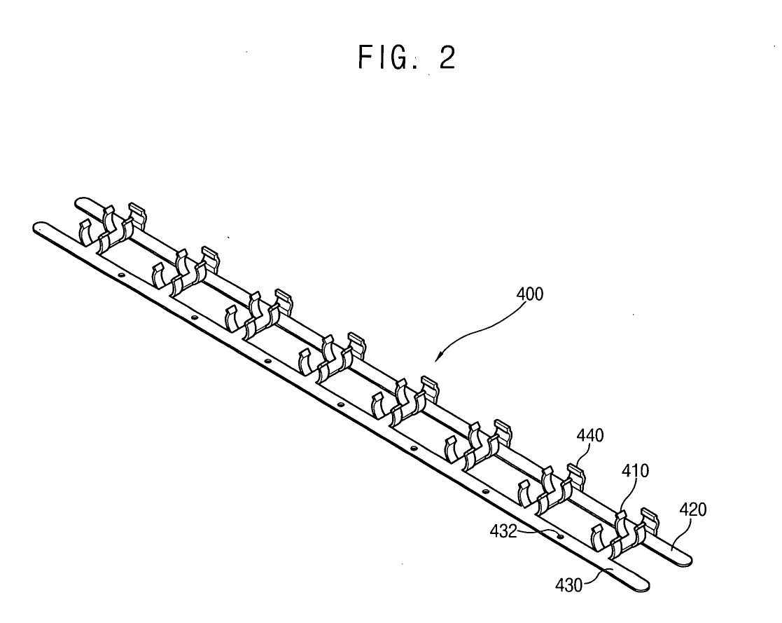

FIG. 2 is a perspective view illustrating the voltage applying part in FIG. 1. Referring to FIGS. 1 and 2, the voltage applying part 400 includes clip portions 410, a first connection portion 420 and a second connection portion 430.

Each of the clip portions 410 grips end portion of each of the lamps 500. The clip portions 410 are spaced apart from one another by substantially the same distance, so that when the lamps 500 are combined with the clip portions 410, the lamps 500 are spaced apart by substantially the same distance.

The first connection portion 420 is disposed such that a longitudinal direction of the first connection portion 420 is substantially perpendicular to a longitudinal direction of the lamps 500. A first end of the clip portion 410 is connected to the first connection portion 420.

The second connection portion 430 is disposed substantially parallel with the first connection portion 420, and a second end of the clip portion 410 is connected to the second connection portion 430.

A protruding portion 440 is connected to the first connection portion 420. The protruding portion 440 protrudes upwardly from the first connection portion 420. The protruding portion 440 prevents the lamp 500 combined with the clip portion 410 from moving in its longitudinal direction beyond the first connection portion 420.

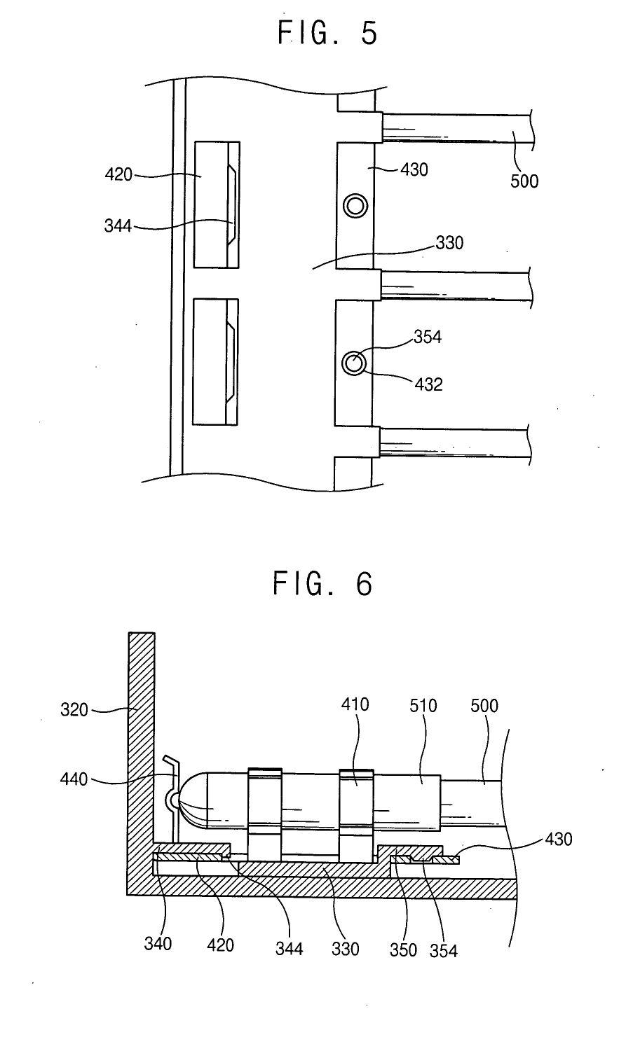

The second connection portion 430 includes holes 432. The voltage applying part 400 is fixed to the first mold 300 using the holes 432. This is described in detail below with reference to FIG. 5.

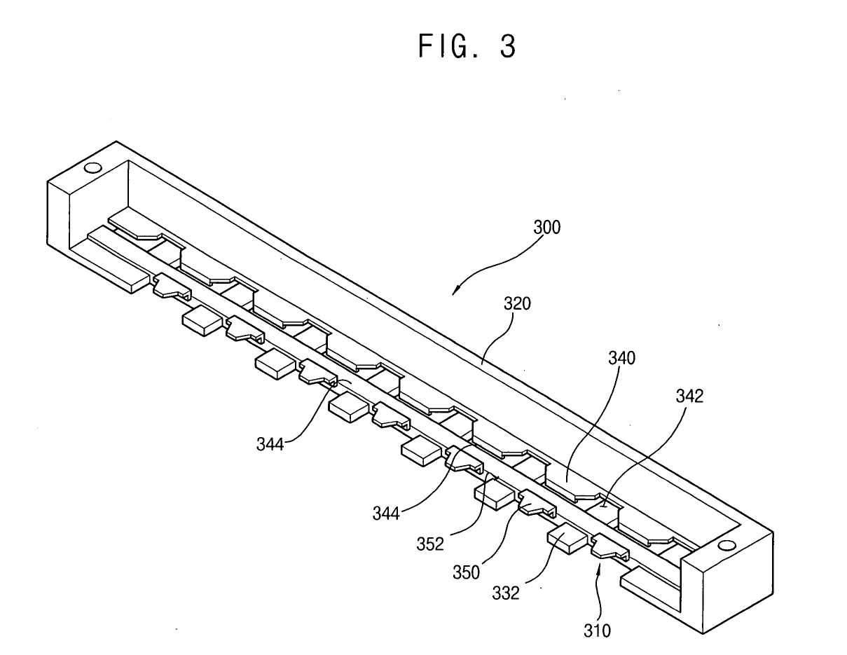

FIG. 3 is a perspective view illustrating the first mold 300 of FIG. 1.

Referring to FIGS. 2 and 3, the first mold 300 includes the combination portion 310 for combining with the voltage applying part 400 that slides along the longitudinal direction of the lamps 500 to be combined with the combination portion 310, and the sidewall 320 extended from an edge of the combination portion 310. The sidewall 320 in placed adjacent to the side portion 220 of the receiving container 200.

The combination portion 310 includes a first combination plate 330 and a second combination plate 340. The first combination plate 330 is extended from a lower portion of the sidewall 320 such that the first combination plate 330 is substantially perpendicular to the sidewall 320. The second combination plate 340 is extended from a portion of the sidewall 320, which is higher than the lower portion, such that the second combination plate 340 is substantially parallel with the first combination plate 330. The first combination plate 330 has extended members 332 each extended in a direction substantially same as the longitudinal direction of the lamps.

The combination portion 310 further includes third combination plates 350. The third combination plate 350 are each extended from an edge of the first combination plate 330 having an angled shape such that it is extended from the first combination plate 330 in a direction substantially parallel to the sidewall 320 by a predetermined distance and then extended in a direction substantially parallel with the second combination plate 340. The upper portion of the respective third combination plates 350 has substantially same height as the second combination plate 340.

The first combination plate 330 supports the voltage applying part 400 when the voltage applying part 400 slides into the first mold 300 to be combined therein.

The first combination plate 330 may have openings disposed below the second and third combination plates 340 and 350. In other words, the extended members of 332 of the first combination plate 330 are spaced apart from each other to form the openings, and the second and third combination plates 340 and 350 are disposed over the openings.

The second combination plate 340 covers an upper portion of the voltage applying part 400 when the voltage applying part 400 is combined with the first mold 300. The second combination plate 340 has openings 342. Therefore, when the voltage applying part 400 is combined with the first mold 300, the protruding portions 440 of the voltage applying part 400 are disposed at the openings 342 of the second combination plate 340. The second combination plate 340 further includes fixing portions 344. Therefore, when the voltage applying part 400 is combined with the first mold 300, the fixing portions 344 securely hold the first connection portion 420 to prevent the voltage applying part 400 drifting from the first mold 300. Each fixing portion 344 is protruded from an edge of the second combination plate 340 toward the first combination plate 330 to make contact with inner edge of the first connection portion 420 of the voltage applying part 400.

The third combination plates 350 cover an upper face of the second connection portion 430 of the voltage applying part 400, when the voltage applying part 400 is combined with the first mold 300. The third combination plates 350 are spaced apart from each other to form openings 352 each for receiving the clip portion 410 of the voltage applying part 400. That is, when the voltage applying part 400 is combined with the first mold 300, each clip portion 410 of the voltage applying part 400 is disposed at corresponding one of the openings 352 formed between the third combination plates 350. Each third combination plate 350 may further include a fixing portion 354 (see FIGS. 5 and 6) to securely hold the second connection portion 430 of the voltage applying part 400.

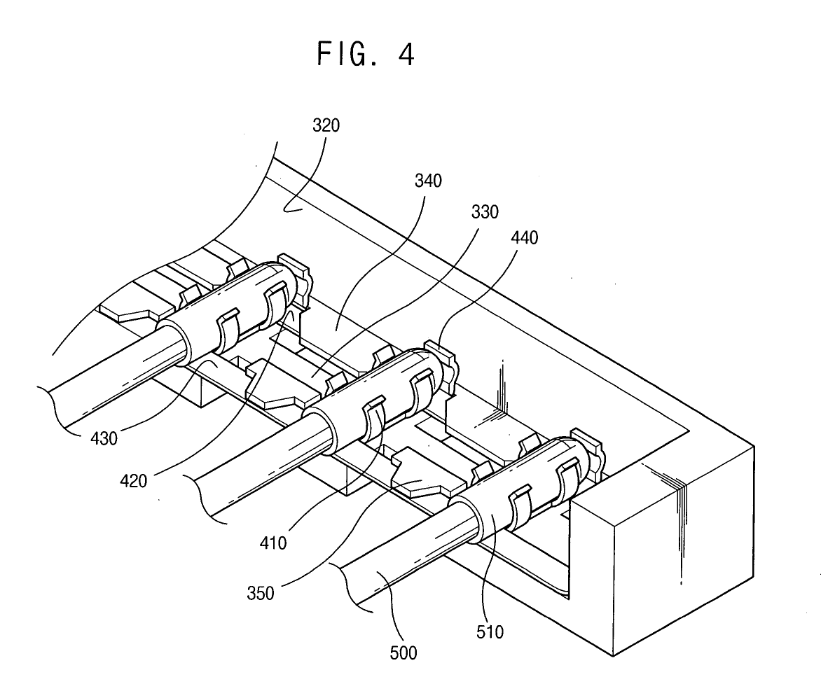

FIG. 4 is a perspective view illustrating the voltage applying part 400 of FIG. 2 and the first mold 300 of FIG. 3 combined with each other. FIG. 5 is a backside view of the combined voltage applying part 400 and first mold 300 shown in FIG. 4, and FIG. 6 is a cross-sectional view of the combined voltage applying part 400 and first mold 300 taken along line I-I′ in FIG. 4.

Referring to FIGS. 4, 5 and 6, the voltage applying part 400 slides toward the sidewall 320 of the first mold 300 to be combined with the first mold 300. In detail, when the first connection portion 420 is disposed between the second and third combination plates 340 and 350, the voltage applying part 400 slides toward the sidewall 320 of the first mold 300 to be fixed. When the voltage applying part 400 slides completely, the protruding portions 440 of the voltage applying part 400 are disposed at the openings 342, respectively, of the second combination plate 340 and the clip portions 410 of the voltage applying part 400 are disposed at the openings 352, respectively, formed between the third combination plates 350. When the voltage applying part 400 is combined with the first mold 300, a lower face of the voltage applying part 400 makes contact with the first combination plate 330, an upper face of the first connection portion 420 makes contact with the second combination plate 340, and an upper face of the second connection portion 430 makes contact with the third combination plates 350.

When the voltage applying part 400 slides completely, the fixing portions 344 of the second combination plate 340 prevent the voltage applying part 400 from sliding toward a direction that is opposite to a sliding direction for fixably attaching the voltage applying part 400 to the first mold 300.

Additionally, a boss 354 formed on the respective third combination plates 350 may fix the voltage applying part 400. Each boss 354 protrudes from the third combination plate 350 toward the first combination plate 330. When the voltage applying part 400 is combined with the first mold 300, the bosses 354 are inserted into the holes 432 formed at the second connection portion 430 of the voltage applying part 400 to fix the second connection portion 430. The protruding portions 440 of the voltage applying part 400 are placed in openings 342 formed at the second combination plate 340 so that the voltage applying part 400 is prevented from moving along a direction that is substantially perpendicular to the longitudinal direction of the lamps 500.

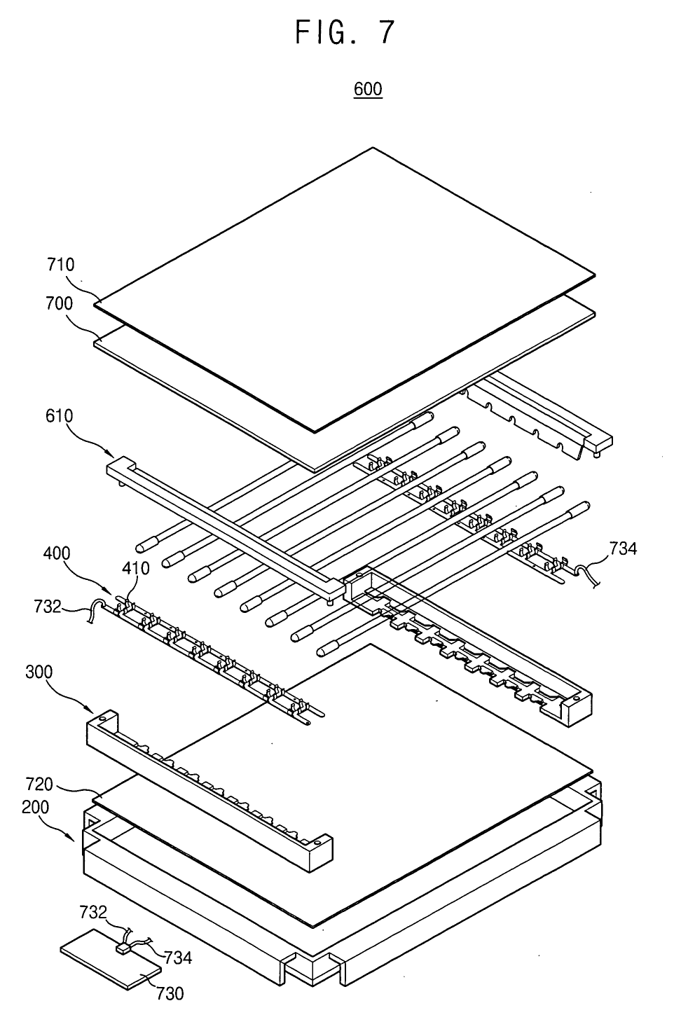

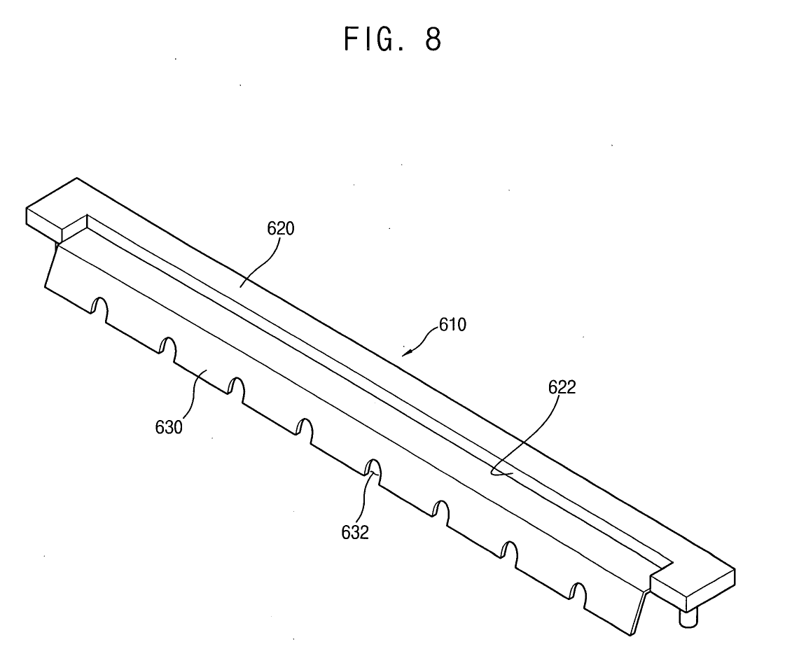

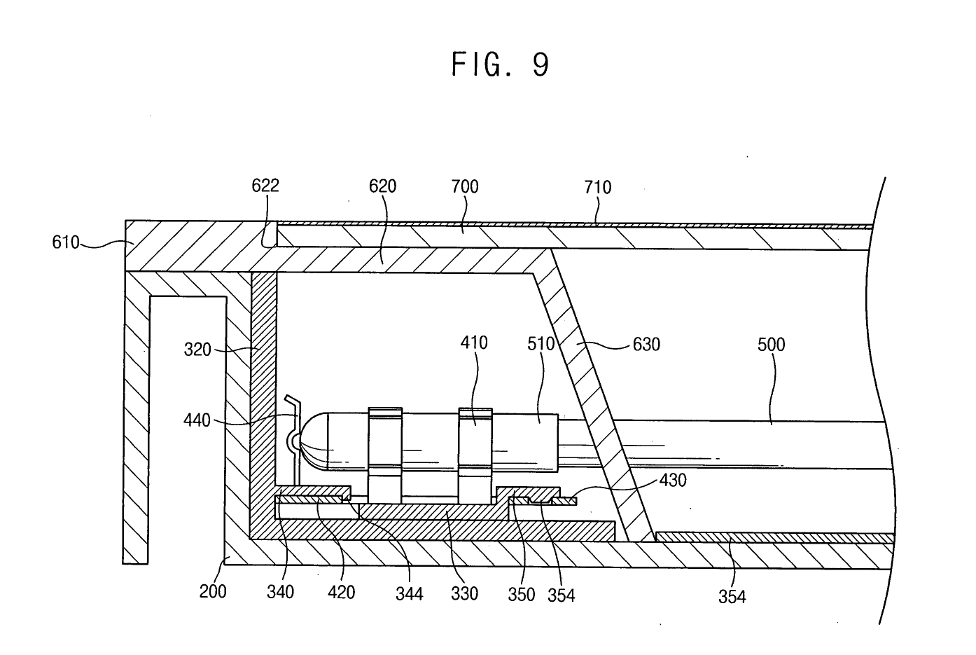

FIG. 7 is an exploded perspective view illustrating a backlight assembly according to another exemplary embodiment of the present invention. FIG. 8 is a perspective view illustrating a second mold shown in FIG. 7, and FIG. 9 is a cross-sectional view illustrating the backlight assembly of FIG. 7. The receiving container, the first mold, the voltage applying part and the lamps of the present embodiment are same as in the previous embodiment. Thus, the same reference numerals will be used to refer to the above-mentioned elements as those described in the previous embodiment and any further explanation will be omitted.

Referring to FIGS. 7, 8 and 9, a backlight assembly 600 according to the present embodiment includes a receiving container 200, a first mold 300, a voltage applying part 400 and lamps 500. The backlight assembly 600 further includes a second mold 610 that covers end portions of the lamps 500. The second mold 610 is combined with the first mold 300.

The second mold 610 is disposed over the voltage applying part 400. The second mold 610 includes an upper portion 620 and an inclined portion 630. The upper portion 620 is substantially parallel with the bottom portion 210 of the receiving container 200, when the second mold 610 is combined with the first mold 300. The inclined portion 630 is extended from an edge of the upper portion 620 forming an obtuse angle with respect to the upper portion 620. The second mold 610 covers a portion of the lamps 500, which does not generate light. The second mold 610 may further include a stepped portion 622 guiding a diffusion plate 700 that is disposed on the second mold 610. The second mold 610 may also include openings or recessed portions 632 at the inclined portion 630. The lamps 500 are disposed through the openings 632 so that the end portions of the lamps 500 are received in a space between the first and second molds 300 and 610.

The backlight assembly 600 further includes the diffusion plate 700. The diffusion plate 700 is supported by the second mold 610 and disposed over the lamps 500. The diffusion plate 700 may have a plate shape. The diffusion plate 700 diffuses light generated from the lamps 500 to uniformize luminance of the light.

The backlight assembly 600 may further include an optical sheet 710. The optical sheet 710 may include a light-condensing sheet that condenses the light diffused by the diffusion plate 700 to enhance a front side luminance or another light diffusing sheet that diffuses again the light diffused by the diffusion plate 700. The backlight assembly 600 may further include any optical property enhancing sheet.

The backlight assembly 600 further includes a reflection plate 720 disposed under the lamps 500. The reflection plate 720 is attached on the bottom portion 210 of the receiving container 200. The reflection plate 720 reflects light generated from the lamps 500 toward the diffusion plate 700.

The backlight assembly 600 further includes an inverter 730. The inverter 730 is disposed on a backside surface of the receiving container 200. The inverter 730 generates driving voltages for driving the lamps 500. The inverter 730 inverts an alternating current of a low level, which is provided from an external source, into driving voltages of a high level. The inverter 730 is electrically connected to the voltage applying part 400 through the first and second power lines 732 and 734, respectively, to provide voltages to the external electrodes 510 of the lamps 500 through the voltage applying part 400.

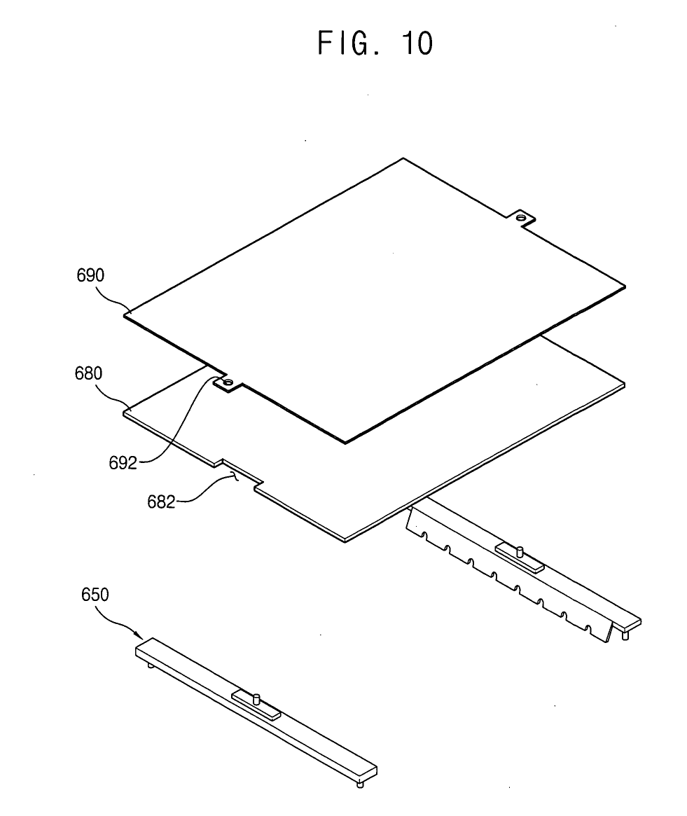

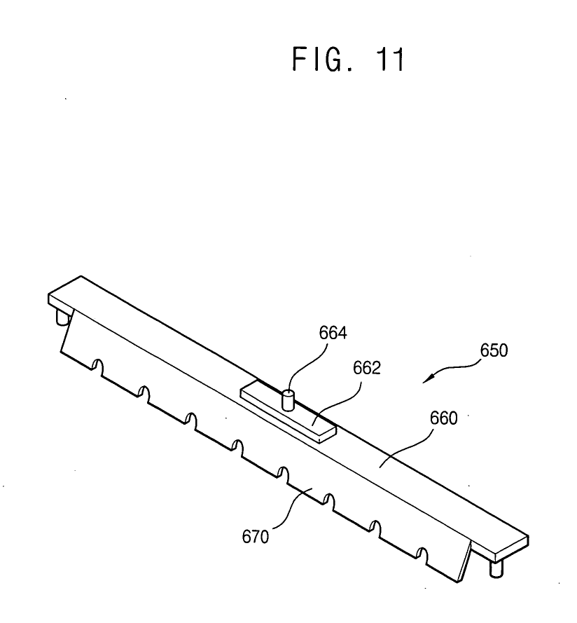

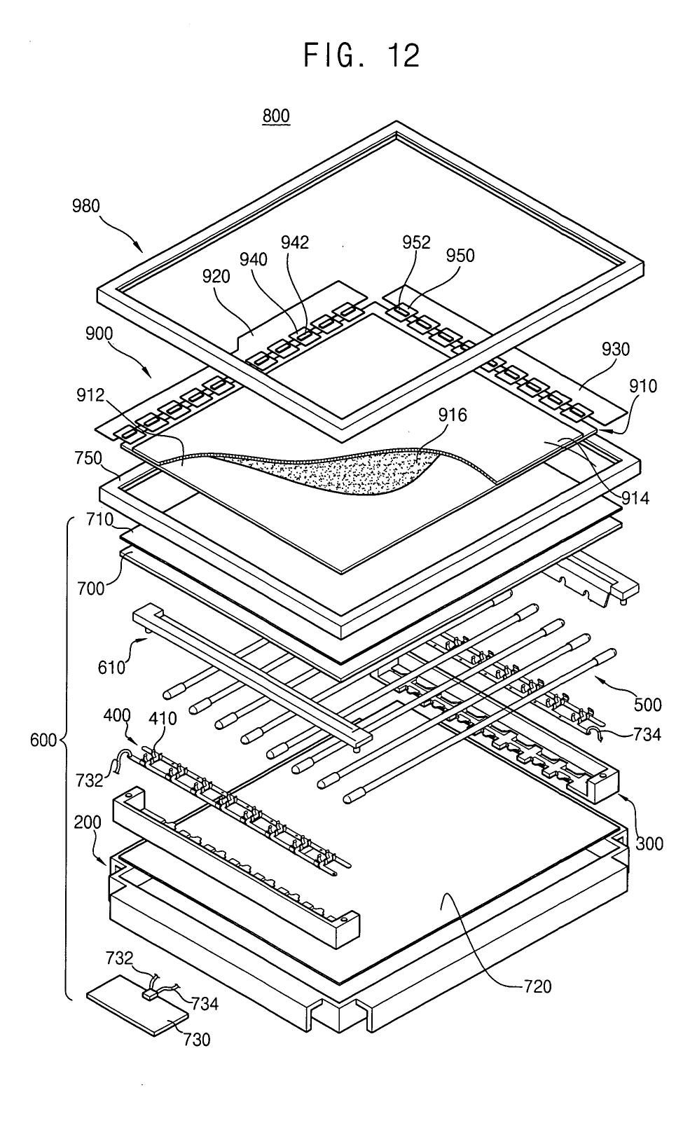

FIG. 10 is an exploded perspective view illustrating a second mold, a diffusion plate and an optical sheet in accordance with an alternative exemplary embodiment, and FIG. 11 is a perspective view illustrating the second mold of FIG. 10.

Referring to FIGS. 10 and 11, a second mold 650 includes an upper portion 660 and an inclined portion 670. The second mold 650 further includes a diffusion plate fixing portion 662 formed on the upper portion 660. A diffusion plate 680 includes a recessed portion 682 corresponding to the diffusion plate fixing portion 662. Therefore, the diffusion plate 680 is fixed to the second mold 650 by means of the recessed portion 682 and the diffusion plate fixing portion 662.

The second mold 650 further includes an optical sheet fixing portion 664. The optical sheet fixing portion 664 has a boss-shape. The optical sheet fixing portion 664 may be formed at any position on the upper portion 660 of the second mold 650. In this embodiment, the optical sheet fixing portion 664 is formed on the diffusion plate fixing portion 662. The optical sheet 690 includes an insertion hole 692 corresponding to the optical sheet-fixing portion 664. The optical sheet 690 is fixed to the second mold 650 by securely inserting the optical sheet fixing portion 664 into the insertion hole 692.

FIG. 12 is an exploded perspective view illustrating a liquid crystal display apparatus according to an exemplary embodiment of the present invention. In the present embodiment, a backlight assembly may be one of the above embodiments. Therefore, a detailed explanation of the backlight assembly will be omitted to avoid duplication.

Referring to FIG. 12, a liquid crystal display (LCD) apparatus 800 includes a display unit 900 that displays images, a backlight assembly 600 that provides the display unit 900 with light, and a top chassis 980 that fixes the display unit 900.

The display unit 900 includes an LCD panel 910 that displays images, data and gate printed circuit boards (PCBs) 920 and 930 that drive the LCD panel 910.

Data and gate driving signals provided from the data and gate PCBs 920 and 930 are applied to the LCD panel 910 through data and gate flexible printed circuits (FPCs) 940 and 950, respectively. The data and gate FPCs 940 and 950 may correspond to a tape carrier package (TCP) or a chip on film (COF). The data and gate FPCs 940 and 950 include data and gate driver chips 942 and 952, respectively. The data and gate driver chips 942 and 952 apply data and gate driving signals provided from the data and gate PCBs 920 and 930, respectively, to the LCD panel 910 under a time control.

The LCD panel 910 includes a thin film transistor (TFT) substrate 912, a color filter substrate 914 facing the TFT substrate 912, and a liquid crystal layer 916 interposed between the TFT substrate 912 and the color filter substrate 914.

The TFT substrate 912 includes a glass substrate and a plurality of TFTs (not shown) formed thereon. Each of the TFTs includes a gate electrode that is electrically connected to one of gate lines (not shown), a source electrode that is electrically connected to one of source lines (not shown), and a drain electrode that is electrically connected to one of pixel electrodes (not shown). The pixel electrode includes optically transparent and electrically conductive material such as indium tin oxide (ITO), indium zinc oxide (IZO), etc.

The color filter substrate 914 includes red (R), green (G) and blue (B) color filters (not shown) and a common electrode (not shown). The common electrode also includes optically transparent and electrically conductive material such as indium tin oxide (ITO), indium zinc oxide (IZO), etc.

When a gate signal is applied to the gate electrode of the TFT, the TFT is turned on so that data signal is applied to the pixel electrode. Therefore, electric fields are formed between the pixel electrode of the TFT substrate 912 and the common electrode of the color filter substrate 914 to change an optical transmittance of the liquid crystal layer 916.

The top chassis 980 surrounds an edge portion of the LCD panel 910 and is combined with the receiving container 200 to fix the LCD panel 910 to the backlight assembly 600. The top chassis 980 protects the LCD panel 910 and prevents the LCD panel 910 from drifting away from the backlight assembly 600.

The LCD apparatus 800 may further include a third mold 750 disposed between the backlight assembly 600 and the LCD panel 910 in order to fix the diffusion plate 700 and the optical sheet 710, and to guide the LCD panel 910.

As described above, the voltage applying part 400 of the backlight assembly 600 is combined with the first mold 300 through a sliding action causing the voltage applying part 400 to become fixably attached to the first mold 300. Therefore, no additional process for combining the voltage applying part 400 with the first mold 300, for example screwing, soldering, etc., is required, thereby lowering the costs of manufacture and enhancing productivity.

Having described the exemplary embodiments of the present invention and its advantages, it is noted that various changes, substitutions and alterations can be made herein without departing from the spirit and scope of the invention as defined by appended claims.

What is claimed is:

1. A backlight assembly comprising:
a receiving container including a bottom portion and a side portion to provide a receiving space;
a first mold disposed in the receiving container;
a voltage applying part disposed in the first mold, the voltage applying part sliding into the first mold to become fixably attached to the first mold, the voltage applying part including a conductive material; and
a plurality of lamps combined with the voltage applying part and disposed substantially parallel to each other, the lamps generating light when a driving voltage is applied to the lamps through the voltage applying part.

2. The backlight assembly of claim 1, wherein each of the lamps comprises an external electrode disposed at an outer surface of an end portion of each lamp, the external electrode being combined with the voltage applying part.

3. The backlight assembly of claim 2, wherein the voltage applying part comprises:
a clip portion that holds the external electrode of the respective lamps;
a first connection portion extended in a direction substantially perpendicular to a longitudinal direction of the lamps, a first end of the clip portion being connected to the first connection portion; and
a second connection portion extended in a direction substantially parallel to a longitudinal direction of the first connection portion, the clip portion being disposed between the first and second connection portions that are spaced apart from each other, a second end of the clip portions being connected to the second connection portion.

4. The backlight assembly of claim 3, wherein the first connection portion comprises a protruding portion for preventing a lamp from moving beyond the first connection portion.

5. The backlight assembly of claim 3, wherein the voltage applying part includes a plurality of clip portions each holding the external electrode of corresponding one of the lamps, the plurality of the clip portions being arranged between the first and second connection portions.

6. The backlight assembly of claim 5, wherein the first connection portion includes a plurality of protruding portions each for preventing each lamp from moving beyond the first connection portion, the plurality of protruding portions being disposed in alignment with the plurality of clip portions, respectively.

7. The backlight assembly of claim 4, wherein the first mold comprises:
a combination portion that is combined with the voltage applying part; and
a sidewall extended from the combination portion and disposed adjacent to the side portion of the receiving container.

8. The backlight assembly of claim 7, wherein the combination portion comprises:
a first combination plate extended from a bottom portion of the sidewall to support the voltage applying part; and
a second combination plate extended from the sidewall to cover an upper surface of the first connection portion of the voltage applying part.

9. The backlight assembly of claim 8, wherein the second combination plate comprises an opening in which the protruding portion of the first connection portion is received.

10. The backlight assembly of claim 9, wherein the second combination plate further comprises a fixing portion protruded toward the first combination plate to securely hold the first connection portion of the voltage applying part.

11. The backlight assembly of claim 8, wherein the combination portion further comprises a third combination plate protruded from the first combination plate to cover an upper surface of the second connection portion of the voltage applying part.

12. The backlight assembly of claim 8, wherein the combination portion includes third combination plates each extended from the first combination plate to cover an upper surface of the second connection portion of the voltage applying part.

13. The backlight assembly of claim 12, wherein the third combination plates are spaced apart from each other to form an opening between the third combination plates, the clip portion of the voltage applying part being received in the opening.

14. The backlight assembly of claim 13, wherein the third combination plates each comprise a boss protruded toward the first combination plate, the boss being in contact with the second connection portion to securely hold the voltage applying part.

15. The backlight assembly of claim 14, wherein the second connection portion includes a hole into which the boss of a corresponding of the third combination plates is inserted.

16. The backlight assembly of claim 1, further comprising a second mold that covers end portions of the lamps and is combined with the first mold.

17. The backlight assembly of claim 16, wherein the second mold includes:
an upper portion substantially parallel to the bottom portion of the receiving container; and
an inclined portion extended from the upper portion toward the bottom portion of the receiving container, the inclined portion including an opening through which a lamp is disposed.

18. The backlight assembly of claim 16, further comprising:
a diffusion plate disposed over the lamps and supported by the second mold;
an optical sheet disposed on the diffusion plate;
a reflection plate disposed under the lamps; and
an inverter disposed on a backside surface of the receiving container, the inverter generating driving voltages for driving the lamps.

19. The backlight assembly of claim 18, wherein the second mold comprises a diffusion plate fixing portion protruded upwardly, the diffusion plate fixing portion preventing the diffusion plate from moving the second mold.

20. The backlight assembly of claim 19, wherein the diffusion plate comprises a recessed portion corresponding to the diffusion plate fixing portion.

21. The backlight assembly of claim 19, wherein the second mold comprises an optical sheet fixing portion protruded from the diffusion plate fixing portion, the optical sheet fixing portion preventing movement of the optical sheet.

22. The backlight assembly of claim 18, wherein the optical sheet comprises a light condensing sheet that condenses light that is diffused by the diffusion plate.

23. The backlight assembly of claim 18, wherein the optical sheet comprises a light diffusing sheet that additionally diffuses light that is diffused by the diffusion plate.

24. A liquid crystal display (LCD) apparatus comprising:
a backlight assembly including a receiving container, a first mold disposed in the receiving container, a voltage applying part that is slidably disposed on the first mold to become fixably attached to the first mold, and lamps, each of lamps having an external electrode formed on outer surface of an end portion of each lamp, the external electrode being combined with the voltage applying part;
a liquid crystal display panel that displays images using light generated by the backlight assembly; and
a top chassis that fixes the liquid crystal display panel to the backlight assembly.

25. The LCD apparatus of claim 24, wherein the voltage applying part comprises:
a clip portion that holds the external electrode of the respective lamps;
a first connection portion extended in a direction substantially perpendicular to a longitudinal direction of the lamps, a first end of the clip portion being connected to the first connection portion; and
a second connection portion extended in a direction substantially parallel to a longitudinal direction of the first connection portion, the clip portion being disposed between the first and second connection portions that are spaced apart from each other, a second end of the clip portion being connected to the second connection portion.

26. The LCD apparatus of claim 25, wherein the first connection portion comprises a protruding portion, for preventing a lamp from moving beyond the first connection portion.

27. The LCD apparatus of claim 26, wherein the first mold comprises:
a combination portion that is combined with the voltage applying part; and
a sidewall extended from the combination portion and disposed adjacent to the side portion of the receiving container.

28. The LCD apparatus of claim 27, wherein the combination portion comprises:
a first combination plate extended from a bottom portion of the sidewall to support the voltage applying part;
a second combination plate extended from the sidewall to cover an upper surface of the first connection portion of the voltage applying part; and
a third combination plate protruded from the first combination plate to cover an upper surface of the second connection portion of the voltage applying part.

29. The LCD apparatus of claim 28, wherein the second combination plate comprises an opening in which the protruding portion of the first connection portion is received.

30. The LCD apparatus of claim 29, wherein the second combination plate further comprises a fixing portion protruded toward the first combination plate to securely hold the first connection portion of the voltage applying part.

31. The LCD apparatus of claim 27, wherein the third combination plate is spaced apart from another third combination plate to form an opening between the third combination plates, the clip portion of the voltage applying part being received in the opening.

32. The LCD apparatus of claim 31, wherein the third combination plate further comprises a boss protruded toward the first combination plate, and the second connection portion includes a hole into which the boss of the third combination plate is inserted.

33. The LCD apparatus of claim 24, wherein the backlight assembly further comprises:
a second mold that covers end portions of the lamps and is combined with the first mold; and
a diffusion plate disposed over the lamps and supported by the second mold.
